(19) United States
(12) Patent Application Publication
(10) Pub. No.: US 2022/0377729 A1
(43) Pub. Date: Nov. 24, 2022

(54) RADIO COMMUNICATION APPARATUS, RADIO COMMUNICATION METHOD, AND RADIO COMMUNICATION SYSTEM

(71) Applicant: Panasonic Intellectual Property Management Co., Ltd., Osaka (JP)

(72) Inventors: Toshihiro TERAOKA, Kanagawa (JP); Naganori SHIRAKATA, Kanagawa (JP); Tomohiro MURATA, Kanagawa (JP); Yohei MORISHITA, Kanagawa (JP)

(21) Appl. No.: 17/881,499

(22) Filed: Aug. 4, 2022

Related U.S. Application Data
(63) Continuation of application No. PCT/JP2021/003872, filed on Feb. 3, 2021.

(30) Foreign Application Priority Data
Feb. 13, 2020 (JP) 2020-022679

(51) Int. Cl. H04W 72/04

(52) U.S. Cl. CPC H04W 72/0406

(57) ABSTRACT

A radio communication apparatus includes: control circuitry, which, in operation, selects, as a radio channel used for transmission, at least one radio channel among a plurality of radio channels based on information on a reduction time of a sum of transmission time per unit time in each of the plurality of radio channels; and radio circuitry, which, in operation, performs transmission using the selected radio channel.

### TECHNICAL FIELD

The present disclosure relates to a radio communication apparatus, a radio communication method, and a radio communication system.

### BACKGROUND ART

For example, there is a radio communication system that performs communication in a frequency band usable without a license, such as a specified low-power radio apparatus (also referred to as a specified low-power radio station) (e.g., Non-Patent Literature (hereinafter, referred to as “NPL”) 1).

### CITATION LIST

### Non Patent Literature

NPL 1
920 MHz-BAND TELEMETER, TELECONTROL AND DATA TRANSMISSION RADIO EQUIPMENT, ARIB STANDARD, ARIB STD-T108 Version 1.3, Association of Radio Industries and Businesses, Apr. 12, 2019, P. 2-24 to P. 2-29

### SUMMARY OF INVENTION

However, there is room for improvement in a method for selecting a radio channel having a limitation on the sum of time available for transmission in a radio communication system using a frequency band usable without a license.

Non-limiting examples of the present disclosure facilitate to providing a radio communication apparatus, a radio communication method, and a radio communication system capable of appropriately selecting a radio channel having a limitation on the sum of time available for transmission.

A radio communication apparatus according to the embodiment of the present disclosure includes: control circuitry, which, in operation, selects, as a radio channel used for transmission, at least one radio channel among a plurality of radio channels based on information on a reduction time of a sum of transmission time per unit time in each of the plurality of radio channels; and radio circuitry, which, in operation, performs transmission using the selected radio channel.

It should be noted that general or specific embodiments may be implemented as a system, an apparatus, a method, an integrated circuit, a computer program, a storage medium, or any selective combination of a system, an apparatus, a method, an integrated circuit, a computer program, and a recording medium.

According to an embodiment of the present disclosure, it is possible to appropriately select a radio channel having a limitation on the sum of time available for transmission.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an exemplary configuration of a radio communication system;

FIG. 2 is a block diagram illustrating an exemplary configuration of a radio apparatus;

FIG. 3 is a flowchart illustrating an exemplary operation of data transmission in a child radio apparatus;

FIG. 4 is a flowchart illustrating an exemplary operation of a channel change request processing in the child radio apparatus;

FIG. 5 is a flowchart illustrating an exemplary operation of a channel change determination processing in a parent radio apparatus;

FIG. 6 is a flowchart illustrating an exemplary operation of a channel change processing in the child radio apparatus; and

FIG. 7 is a sequence diagram illustrating an exemplary operation of a radio channel change in the radio communication system.

### DESCRIPTION OF EMBODIMENTS

Hereinafter, an embodiment of the present disclosure will be described in detail with reference to the accompanying drawings. Note that the embodiment described below is merely an example, and the present disclosure is not limited by the following embodiment.

For example, a limitation may be applied on the transmission time per unit time for a radio apparatus to share a frequency band usable without a license by a plurality of systems. For example, in the standard of the 920-MHz band in Japan, it is specified that the sum of the transmission time per certain time (in other words, Duty ratio) is limited to 10% or less (e.g., see NPL 1). For example, in NPL 1, the sum of transmission time capable of transmission in the same radio channel is specified to be 360 seconds or less per hour.

For example, when the sum of transmission time per unit time of a certain radio channel has exceeded a specified value (e.g., 360 seconds per hour), the radio apparatus does not transmit a signal, using the radio channel. For example, the radio apparatus pauses transmission on the radio channel in which the sum of transmission time per unit time has exceeded a specified value until the sum of transmission time per unit time decreases to less than the specified value.

Further, in NPL 1, when a radio apparatus uses a plurality of radio channels by switching channels, it is specified that the sum of transmission time per hour in one radio apparatus (e.g., the total of sums of transmission time in a plurality of radio channels) is 720 seconds or less, and the sum of transmission time per hour in each radio channel is 360 seconds or less. Switching radio channels used for transmission increases a transmission opportunity by one radio apparatus even though the limitation on the sum of transmission time per radio channel is applied.

Here, when one radio channel used for transmission is switched among a plurality of radio channels in one radio apparatus, the same radio channel may be repeatedly selected, for example. In this case, since the sum of transmission time per unit time of the repeatedly-selected radio channel easily exceeds the specified value, the probability of the radio channel pausing transmission increases.

In one embodiment of the present disclosure, a method for reducing the probability of a radio channel pausing transmission by appropriately selecting individual radio channels in which the sum of transmission time per unit time is specified will be described.

[Exemplary Configuration of Radio Communication System]

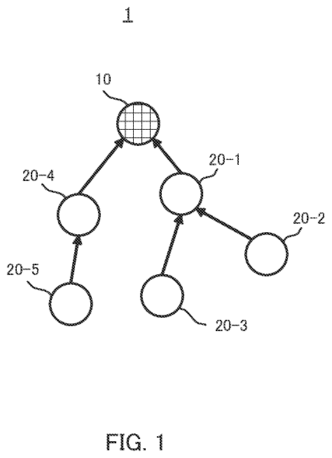

FIG. 1 is a diagram illustrating an exemplary configuration of radio network (or also referred to as radio communication system) 1 according to an embodiment of the present disclosure. The radio network illustrated in FIG. 1 is, for example, a tree-type network.

Radio network 1 illustrated in FIG. 1 includes, for example, one parent radio apparatus 10 and five child radio apparatuses 20-1 to 20-5. Hereinafter, when child radio apparatuses 20-1 to 20-5 are not distinguished from each other, the child radio apparatuses are referred to as “child radio apparatus 20”, for example. Each of parent radio apparatus 10 and child radio apparatuses 20 may be, for example, a radio apparatus such as a specified low-power radio apparatus. The term “parent radio apparatus” may be referred to as “parent station” or “parent node” and “child radio apparatus” may be referred to as “child station” or “child node”.

Parent radio apparatus 10 may, for example, transmit a signal such as a transmission signal including a beacon and a control signal to child radio apparatus 20 by radio. Further, parent radio apparatus 10 may receive a signal, such as data and a control signal, transmitted by radio from child radio apparatus 20, for example. The signal received from child radio apparatus 20 may include, for example, information on a radio channel change, which will be described later. In addition, parent radio apparatus 10 may control the setting of a radio channel to child radio apparatus 20, for example.

On the other hand, child radio apparatus 20 may, for example, receive a signal, such as a beacon or a control signal, by radio from parent radio apparatus 10. For example, a plurality of child radio apparatuses 20 may perform time synchronization by a beacon. Also, child radio apparatus 20 may transmit a signal, such as data or a control signal, to parent radio apparatus 10, for example.

Further, in the embodiment illustrated in FIG. 1, child radio apparatus 20-1 relays communication between each of child radio apparatuses 20-2 and 20-3 and parent radio apparatus 10. Similarly, child radio apparatus 20-4 relays communication between child radio apparatus 20-5 and parent radio apparatus 10, for example. In other words, child radio apparatuses 20-1 and 20-4 transfer a signal received from lower child radio apparatus 20 to parent radio apparatus 10, and transfer a signal received from parent radio apparatus 10 to lower child radio apparatus 20.

Each of parent radio apparatus 10 and child radio apparatuses 20 may, for example, collect data from a variety of devices or sensors. For example, in FIG. 1, parent radio apparatus 10 may collect data (e.g., sensor data) measured at a sensor (not illustrated) connected to child radio apparatuses 20-2, 20-3, and 20-5 through each child radio apparatus 20. In this case, as illustrated in FIG. 1, the data transmitted from each of child radio apparatuses 20-2, 20-3, and 20-5 is transmitted to parent radio apparatus 10 in a path indicated by arrows.

For example, when data collection is performed in a tree-type network as illustrated in FIG. 1, upper child radio apparatus 20 closer to parent radio apparatus 10 has a larger number of lower child radio apparatuses 20, each of which is a target of data reception; therefore, the amount of received data of upper child radio apparatus 20 is likely to increase.

Note that the configuration of radio network 1 illustrated in FIG. 1 is an example, and the number of parent radio apparatuses 10 and the number of child radio apparatuses 20, the connection relationship, or the topology (tree type in FIG. 1) is not limited to the example illustrated in FIG. 1.

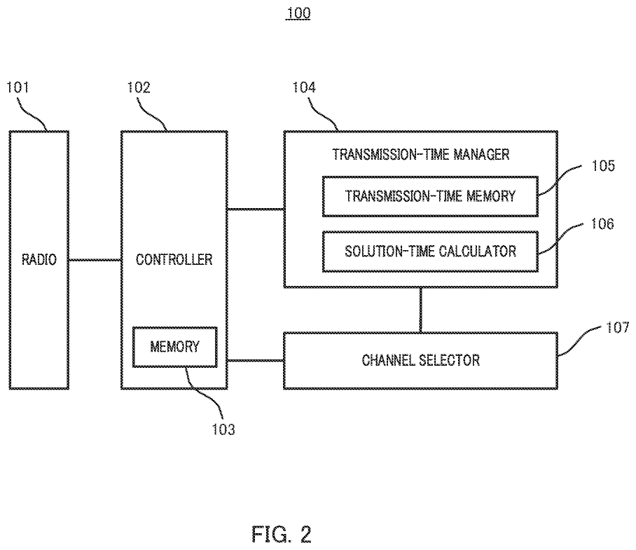

FIG. 2 is a block diagram illustrating an exemplary configuration of radio apparatus 100 according to the embodiment of the present disclosure. Each of parent radio apparatus 10 and child radio apparatuses 20-1 to 20-5 illustrated in FIG. 1 may include, for example, the configuration of radio apparatus 100 illustrated in FIG. 2.

Radio apparatus 100 illustrated in FIG. 2 may include, for example, radio 101, controller 102, transmission-time manager 104, and channel selector 107.

Radio 101 may include, for example, frequency switching circuitry that selects a radio channel and operates, and radio transmission and reception circuitry that performs radio transmission and reception. For example, radio 101 may set (in other words, switch) any one of a plurality of radio channels to a radio channel used for communication (e.g., at least one of transmission and reception) under the control of controller 102. For example, radio 101 performs at least one of radio transmission and reception with another radio apparatus.

Controller 102 controls, for example, radio 101 (in other words, at least one of transmission and reception of a signal, such as data or a control signal). Further, for example, controller 102 indicates a radio channel (hereinafter, referred to as “operation channel” or “used channel” for convenience) with which radio 101 operates (in other words, radio 101 uses) to radio 101. Controller 102 (e.g., parent radio apparatus 10) may set, for example, a radio channel selected by channel selector 107, which will be described later, as an operation channel of radio 101. Alternatively, controller 102 (e.g., child radio apparatus 20) may, for example, set an operation channel of radio 101 based on information received (or notified) from another radio apparatus (e.g., parent radio apparatus 10 or upper child radio apparatus 20).

Controller 102 may also include memory 103 for storing, for example, information such as “channel change request flag” and “resolution time”. The information on the channel change request flag and the information on the resolution time may, for example, be transmitted (in other words, reported or notified) from child radio apparatus 20 to parent radio apparatus 10.

The “channel change request flag” is, for example, information indicating the presence or absence of a change request of a radio channel in radio apparatus 100 (e.g., child radio apparatus 20). For example, the channel change request flag may indicate that the sum of transmission time per unit time has exceeded a specified value in at least one of the plurality of radio channels in radio apparatus 100. Hereinafter, as an example, the channel change request flag is set to “0” when the sum of transmission time per unit time in radio apparatus 100 is equal to or less than a threshold value (an example of the threshold value will be described later). Further, for example, the channel change request flag is set to “1” when the sum of transmission time per unit time of a certain radio channel has exceeded a threshold value in radio apparatus 100. In addition, for example, the channel change request flag is set to “2” when the sum of transmission time per unit time in one radio apparatus has exceeded a threshold value.

The “resolution time” is, for example, information on reduction time of the sum of transmission time per unit time for each of a plurality of radio channels. For example, the resolution time is information on a period of time or a time until the sum of transmission time per unit time in a radio channel decreases to less than a threshold value with respect to a specified value. For example, the resolution time may be information indicating a period of time required for the sum of transmission time per unit time in a radio channel to decrease to less than the threshold value, or may be information indicating a time at which the sum of transmission time decreases to less than the threshold value. An example of the resolution time will be described later.

Transmission-time manager 104 manages transmission time per radio channel or per one radio apparatus in radio apparatus 100. In other words, transmission-time manager 104 manages a specified sum of transmission time. Transmission-time manager 104 may include, for example, transmission-time memory 105 and solution-time calculator 106.

Transmission-time memory 105 stores the time (transmission time) in which a signal is transmitted in radio apparatus 100. For example, transmission-time memory 105 may store the sum of transmission time per unit time (e.g., one hour) per radio channel.

For example, transmission-time memory 105 may store an accumulated transmission time per radio channel or per one radio apparatus. When referring to the sum of transmission time per unit time, transmission-time memory 105 may set the difference between the accumulated value at a certain time (e.g., current time) and the accumulated value at a time unit time (e.g., one hour) before the certain time as a sum of transmission time per unit time.

Further, transmission-time memory 105 may also store the sum of transmission time per unit time in radio apparatus 100 (in other words, one radio apparatus) by adding (or totaling) transmission time for each of a plurality of radio channels which radio apparatus 100 can use.

Solution-time calculator 106 calculates (in other words, predicts or estimates) the above-described resolution time per radio channel, based on the sum of transmission time per unit time stored in transmission-time memory 105, for example. Also, solution-time calculator 106 may calculate a resolution time with respect to the sum of transmission time per unit time in one radio apparatus 100.

For example, the sum of transmission time per unit time of a certain radio channel decreases with the elapse of time when the radio channel continues not to be used. Further, the degree of reduction (or reduction rate) of the sum of transmission time per unit time may be different in accordance with, for example, changes in the past transmission time in the radio channel. For example, as transmission is concentrately performed in a shorter period of time within the time unit in a certain radio channel, the timing at which the sum of transmission time per unit time starts decreasing may be later. Thus, the sum of transmission time per unit time in the radio channel may hardly decrease, and the resolution time may be longer. In other words, for example, as transmission is dispersively performed within the unit time in a certain radio channel, the timing at which the sum of transmission time per unit time starts decreasing may be earlier. Thus, the sum of transmission time per unit time of the radio channel may easily decrease, and the resolution time may be shorter.

A threshold value (threshold value with respect to a specified value) used for calculation (or determination) of the resolution time may be, for example, a value of 30% of a specified value. As an example, as described above, the specified value of the sum of transmission time per time unit is 360 seconds or less per hour for one radio channel and 720 seconds or less per hour for one radio apparatus in a specified low-power radio apparatus in the 920 MHz band. Thus, the threshold value used for determination of the resolution time may be set to, for example, 108 seconds for one radio channel and 216 seconds for one radio apparatus 100. Solution-time calculator 106 may, for example, set a period of time taken for the sum of transmission time per unit time of a radio channel or radio apparatus 100 to decrease to less than the threshold value (e.g., 108 or 216 seconds), or a time when the sum of transmission time decreases to less than the threshold value to a resolution time.

Note that the threshold value used for determination of the resolution time is not limited to 30% of the specified value, and may be another rate (in other words, any value smaller than the specified value). Also, here, the same rate (e.g., 30%) is applied with respect to the specified value for a radio channel and radio apparatus 100 when the threshold value as to the resolution time is determined, but the present disclosure is not limited to this, and different rates may be applied to the radio channel and radio apparatus 100, or a different rate may be applied to each radio channel.

For example, channel selector 107 selects a radio channel (in other words, an operation channel) to be set in radio 101 among a plurality of radio channels. For example, channel selector 107 may select a radio channel to be set in radio 101 among a plurality of selectable radio channels based on information on a channel change request flag and a resolution time notified from another radio apparatus 100 (e.g., child radio apparatus 20). For example, channel selector 107 may select a radio channel whose resolution time is shorter (or the time is earlier; the same will apply in the following).

For example, channel selector 107 may determine a usage status of a selectable radio channel. Channel selector 107 may determine the usage status, for example, whether another radio apparatus 100 uses the selectable radio channel, or the degree of occupation of the selectable radio channel by another radio apparatus 100. Channel selector 107 may, for example, determine whether a radio channel is being used in another radio apparatus 100 or another radio communication system based on the usage status of the radio channel. Then, channel selector 107 may, for example, select a radio channel to be set in radio 101 based on the usage status of the radio channel, the channel change request flag, and the resolution time.

[Exemplary Operation of Radio Apparatus]

An exemplary operation of radio apparatus 100 (e.g., parent radio apparatus 10 and child radio apparatus 20) in radio network 1 will be described.

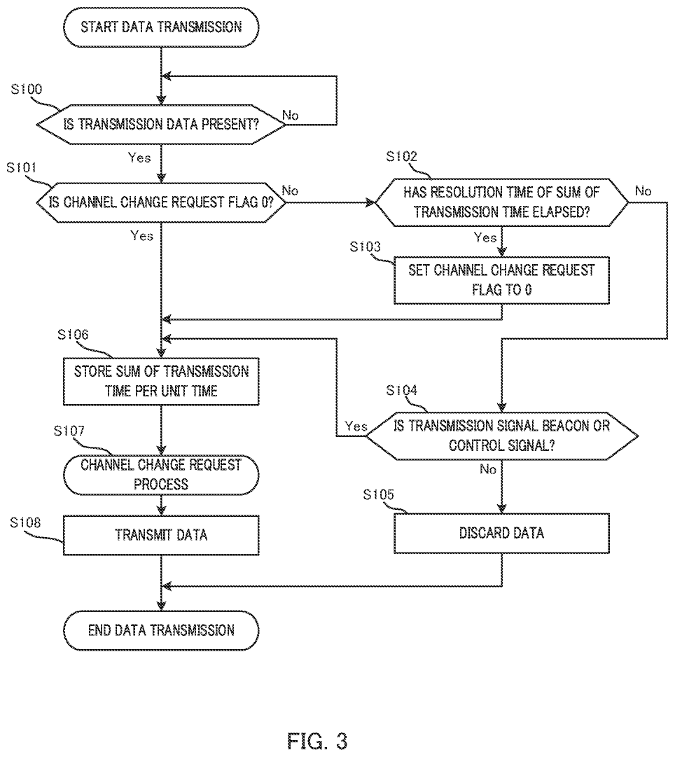

FIG. 3 is a flowchart illustrating an exemplary operation of processing related to data transmission in child radio apparatus 20, for example.

Child radio apparatus 20, for example, determines the presence or absence of transmission data (S100). The transmission data may be, for example, data generated in child radio apparatus 20 or an external device (e.g., a sensor) connected to child radio apparatus 20, or may be data (in other words, transferred data) transmitted from another radio apparatus 100 (e.g., lower child radio apparatus 20). When no transmission data is present (S100: No), child radio apparatus 20 returns to the process of S100.

When transmission data is present (S100: Yes), child radio apparatus 20 determines whether a channel change request flag is 0 (zero) (S101). When the channel change request flag is 0 (S101: YES), child radio apparatus 20 proceeds to the process of S106.

When the channel change request flag is not 0 (S101: No), child radio apparatus 20 determines whether a resolution time corresponding to the sum of transmission time per unit time of each radio channel or one radio apparatus has elapsed (S102). In other words, child radio apparatus 20 determines whether the sum of transmission time per unit time is less than a threshold value. For example, child radio apparatus 20 may determine the elapse of the resolution time based on the resolution time of the radio channel when the channel change flag is 1, or based on the resolution time of radio apparatus when the channel change request flag is 2. The term “determine” may be mutually replaced with other terms such as “judge”, “discriminate”, “detect”, and “notice”.

When the resolution time has elapsed (S102: Yes), child radio apparatus 20 sets the channel change request flag to 0 (S103), for example, and proceeds to the process of S106.

When the resolution time has not elapsed (S102: No), child radio apparatus 20, for example, determines whether the transmission signal is another signal different from a signal such as a beacon and a control signal (S104). When the transmission signal is a beacon or a control signal (S104: Yes), child radio apparatus 20 proceeds to the process of S106. The transmission signal for the determination subject in S104 is not limited to a beacon or a control signal, and may be, for example, another signal having a high priority (or importance) for transmission compared to the data.

When the transmission signal is not a beacon or a control signal (S104: No), child radio apparatus 20 may discard (in other words, abandon) the data (S105) and may terminate the data transmission process. Child radio apparatus 20 can follow the limitation on the specified sum of transmission time by discarding the data.

In FIG. 3, when the channel change request flag is 0 (S101: Yes), when the channel change request flag is set to 0 (after the process of S103), or when a transmission signal is a beacon or a control signal (S104: Yes), child radio apparatus 20 stores (in other words, updates) the sum of transmission time per unit time, for example (S106).

Then, child radio apparatus 20 performs, for example, a channel change request process (S107). An example of the channel change request processing will be described later.

Child radio apparatus 20 transmits a signal (data, a beacon, or a control signal), for example (S108).

Note that, when the transmission signal is a beacon or a control signal (S104: YES), child radio apparatus 20 may skip the channel change request processing, for example. In other words, a beacon and a control signal are signals excluded from the limitation on the sum of transmission time specified for child radio apparatus 20, and thus may be transmitted regardless of the limitation on the sum of transmission time.

However, a beacon or a control signal may be a subject of the limitation on the sum of transmission time without any limitation to the above. In this case, child radio apparatus 20 may not perform the process of S104 illustrated in FIG. 3.

[Channel Change Request Processing]

Next, an exemplary channel change request processing in child radio apparatus 20 will be described.

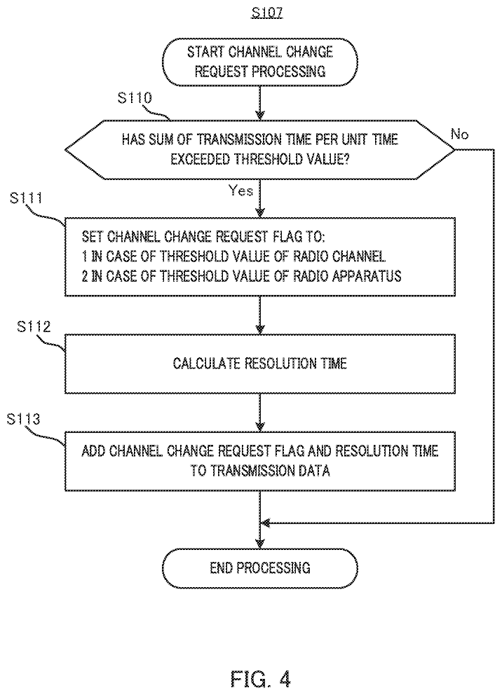

FIG. 4 is a flowchart illustrating an exemplary operation of a channel change request processing (e.g., the process of S107 illustrated in FIG. 3) in child radio apparatus 20.

For example, child radio apparatus 20 determines whether the sum of transmission time per unit time has exceeded a threshold value (hereinafter, sometimes referred to as a “limit threshold value” for convenience) (S110).

For example, child radio apparatus 20 may compare the sum of transmission time per unit time to the threshold value for each of a specified value of 360 seconds for a radio channel and a specified value of 720 seconds for one radio apparatus. For example, when the threshold value is set to a value of 99% with respect to the specified value, the threshold value for one radio channel may be set to 356.4 seconds and the threshold value for one radio apparatus 100 may be set to 712.8 seconds. Child radio apparatus 20 may determine, for example, whether the sum of transmission time per unit time of each radio channel has exceeded 356.4 seconds. Also, child radio apparatus 20 may determine, for example, whether the sum of transmission time per unit time of child radio apparatus 20 (e.g., the total of sums of transmission time of a plurality of radio channels) has exceeded 712.8 seconds.

For example, according to the determination based on the threshold value of 99% with respect to the specified value, child radio apparatus 20 can perform the channel change request before the sum of transmission time per unit time exceeds the specified value, and thus the probability of pausing transmission can be reduced.

Note that the rate of the threshold value with respect to the specified value is not limited to 99%, and may be another rate (e.g., any rate of 100% or less). Further, the threshold value for the sum of transmission time per unit time in each of a radio channel and radio apparatus 100 is not limited to the case where the same ratio (e.g., 99%) is applied with respect to the specified value, and different rates may be applied to a radio channel and radio apparatus 100.

When the sum of transmission time per unit time of each radio channel and one radio apparatus is equal to or less than the threshold value (S110: No), child radio apparatus 20 may terminate the channel change request processing. In other words, child radio apparatus 20 may not perform a channel change request when the sum of transmission time per unit time is equal to or less than the threshold value.

When the sum of transmission time per unit time of each radio channel and one radio apparatus has exceeded the threshold value (S110: Yes), child radio apparatus 20 changes the channel change request flag (S111). For example, when the sum of transmission time per unit time for the radio channel has exceeded the threshold value (e.g., 356.4 seconds), child radio apparatus 20 changes the channel change request flag from 0 to 1. Also, for example, when the sum of transmission time per unit time for one radio apparatus has exceeded the threshold value (e.g., 712.8 seconds), child radio apparatus 20 changes the channel change request flag from 0 to 2. Note that, when the sum of transmission time per unit time for both a radio channel and one radio apparatus has exceeded the threshold value, child radio apparatus 20 may change the channel change request flag from 0 to 2. Child radio apparatus 20 stores the changed channel change request flag, for example.

Child radio apparatus 20, for example, calculates (or decides) a time in or at which the limitation on the sum of transmission time per unit time is resolved (e.g., a resolution time indicating a period of time taken for the limitation to be resolved or a time of the resolution) (S112). For example, child radio apparatus 20 may calculate each of a resolution time for each of the radio channels and a resolution time for one radio apparatus. In the example described above, child radio apparatus 20 may calculate a resolution time indicating a period of time taken until or a time at which the sum of transmission time per unit time in each radio channel becomes 108 seconds or less. Further, child radio apparatus 20 may, for example, calculate a resolution time indicating a period of time or a time taken for the sum of transmission time per unit time in child radio apparatus 20 to become 216 seconds or less. Child radio apparatus 20 stores the calculated resolution time, for example.

Child radio apparatus 20, for example, adds information indicating the channel change request flag and the resolution time to transmission data (S113). For example, the information indicating the channel change request flag and the resolution time may be added to the data section of a signal (e.g., also referred to as the payload section) or may be added to the header section of a signal.

Note that, when the flag is 1 and there is a radio channel in which the sum of transmission time per unit time does not exceed the specified value, child radio apparatus 20 may add information indicating the channel change request flag and the resolution time to the transmission data. Also, when the sum of transmission time per unit time has exceeded the specified value for a radio channel (flag 1) or the specified value for one radio apparatus (flag 2), child radio apparatus 20 may, for example, discard the data section of the transmission data to be transmitted by child radio apparatus 20, and may use a control signal in which the channel change request and the resolution time has been added as the transmission data.

By the above-described operation, when the sum of transmission time per unit time in a radio channel has exceeded a threshold value (or a specified value) (the flag is 1 or 2) in child radio apparatus 20, the channel change request flag is notified from child radio apparatus 20 to parent radio apparatus 10. In other words, child radio apparatus 20 requests parent radio apparatus 10 to change a channel when the sum of transmission time per unit time has exceeded a threshold value.

Also, child radio apparatus 20 may notify parent radio apparatus 10 of information on the resolution time of the plurality of radio channels when requesting the channel change.

The operation example of the channel change request processing has been described above.

[Channel Change Determination Processing]

Next, exemplary channel change determination processing in parent radio apparatus 10 will be described.

Parent radio apparatus 10, for example, performs a channel change determination processing (in other words, selects a radio channel used for transmission) when the channel change request flag included in the signal notified from child radio apparatus 20 is 1 or 2.

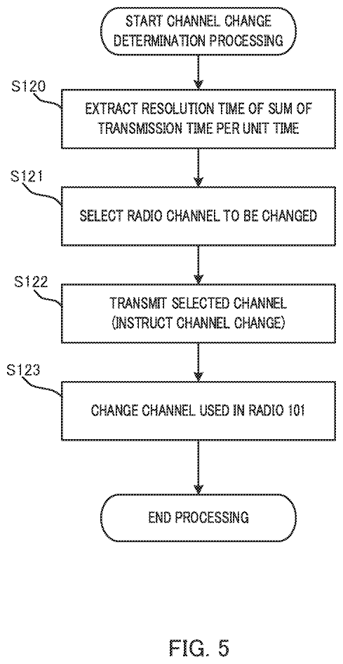

FIG. 5 is a flowchart illustrating an exemplary operation of a channel change determination processing in parent radio apparatus 10.

Parent radio apparatus 10, for example, extracts (or detects) information on the resolution time of the sum of transmission time per unit time included in the signal notified from child radio apparatus 20 (S120).

Parent radio apparatus 10, for example, selects a radio channel of a change destination in response to a channel change request from child radio apparatus 20 (S121).

Parent radio apparatus 10 may, for example, select a radio channel based on the resolution time notified from child radio apparatus 20. Alternatively, parent radio apparatus 10 may, for example, select a radio channel based on the usage status of the radio channel and the resolution time notified from child radio apparatus 20.

Here, since a radio channel with a shorter resolution time can be a radio channel with a smaller sum of transmission time per unit time, it is likely that the remaining transmission time until the radio transmission is limited by the specification of the sum of transmission time per unit time is longer. In other words, a radio channel with a shorter resolution time is likely to have more opportunities of transmission in child radio apparatus 20. In addition, even when the sum of transmission time per unit time is the same in a plurality of radio channels, distributed transmission is performed, and thus it is less likely that radio transmission is limited by the specification of the sum of transmission time per unit time in a radio channel with a shorter resolution time.

Then, for example, when the channel change request flag is 1, parent radio apparatus 10 may select a radio channel to be changed based on the resolution time of the sum of transmission time per unit time of each radio channel. For example, parent radio apparatus 10 may preferentially select a radio channel with a shorter resolution time among a plurality of radio channels. In this case, parent radio apparatus 10 may preferentially select a radio channel that is less likely to be interfered with, based on the usage status of the selectable radio channels.

Further, for example, when the channel change request flag is 2, parent radio apparatus 10 may determine that the radio transmission may be limited by the limitation of the sum of transmission time per unit time for one radio apparatus even when the radio channel is changed. In this case, parent radio apparatus 10 may select (in other words, reselect) a currently selected (or used) radio channel without changing a radio channel.

Parent radio apparatus 10 transmits information on the selected radio channel (for example, referred to as channel change instruction information) to child radio apparatus 20 (S122). For example, parent radio apparatus 10 may notify subordinate child radio apparatus 20 of channel change instruction information by broadcasting. For example, in FIG. 1, the channel change instruction information may be transmitted from parent radio apparatus 10 to child radio apparatuses 20-1 and 20-4. Further, channel change instruction information may be transmitted from child radio apparatus 20-1 to child radio apparatuses 20-2 and 20-3, and may be transmitted from child radio apparatus 20-4 to child radio apparatus 20-5.

Parent radio apparatus 10, for example, changes the radio channel used in parent radio apparatus 10 (e.g., radio 101) to the selected radio channel (S123).

Note that in FIG. 5, a case where parent radio apparatus 10 does not change a radio channel when the channel change request flag is 2 has been described, but the present disclosure is not limited thereto. For example, even when the channel change request flag is 2, parent radio apparatus 10 may, for example, select (in other words, change) a radio channel based on the resolution time. This process, for example, allows each radio apparatus 100 to communicate in a radio channel with a shorter resolution time when the limitation on the sum of transmission time per unit time for one radio apparatus 100 is resolved, which can reduce the probability of pausing transmission again.

The example of the channel change determination processing in parent radio apparatus 10 has been described above.

Next, an exemplary process of changing a channel in child radio apparatus 20 will be described.

Child radio apparatus 20 performs channel change processing when receiving the channel change instruction information from parent radio apparatus 10, for example.

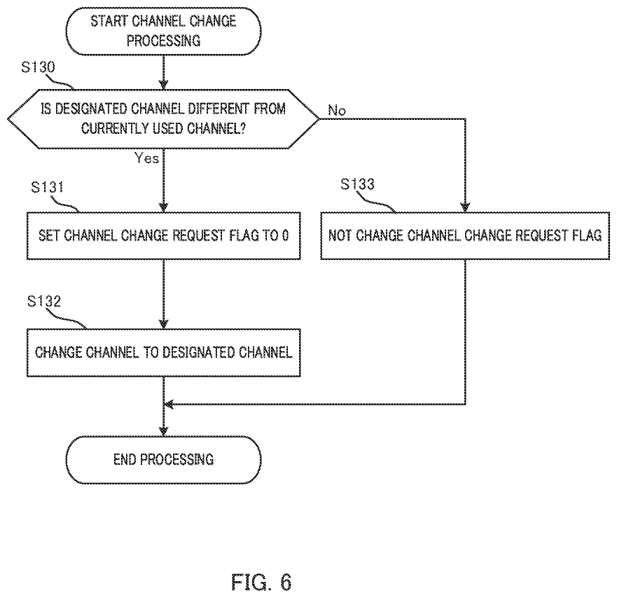

FIG. 6 is a flowchart illustrating an exemplary operation of the channel change processing in child radio apparatus 20.

Child radio apparatus 20 determines whether the radio channel indicated in the channel change instruction information notified from parent radio apparatus 10 (in other words, the designated radio channel) is different from the currently used radio channel (S130).

When the designated radio channel is different from the radio channel being used (S130: Yes), child radio apparatus 20, for example, sets the channel change request flag to 0 (S131), and changes the radio channel used in radio 101 to the designated radio channel (S132). However, the channel change request flag may not be changed when the channel change request flag is 2 in the process of S131, for example.

On the other hand, when the designated radio channel and the radio channel being used are the same (S130: No), child radio apparatus 20 may terminate the channel change processing without changing the channel change request flag (S133), for example.

The example of the channel change processing in child radio apparatus 20 has been described above.

[Exemplary Operation of Radio Network 1]

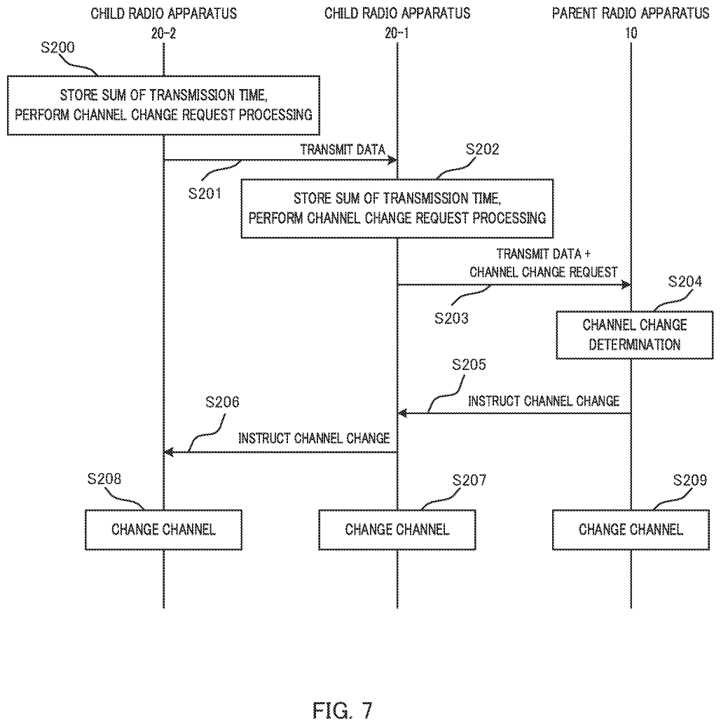

FIG. 7 is a sequence diagram illustrating an exemplary operation of parent radio apparatus 10 and child radio apparatus 20 when a radio channel is changed in radio network 1 described above.

As an example, FIG. 7 illustrates an exemplary operation (e.g., data transmission, channel change request, channel change determination, or channel change) in parent radio apparatus 10, child radio apparatus 20-1, and child radio apparatus 20-2 in radio network 1 illustrated in FIG. 1.

In FIG. 7, child radio apparatus 20-2 stores (in other words, updates) the sum of transmission time each time data transmission is performed, and performs channel change request processing (in other words, determining whether a radio channel change is necessary, e.g., FIG. 4) (S200). In the example illustrated in FIG. 7, child radio apparatus 20-2 determines not to request a change of a radio channel. Then, child radio apparatus 20-2, for example, transmits data to child radio apparatus 20-1 (upper child radio apparatus 20) (S201).

After receiving data from child radio apparatus 20-2, child radio apparatus 20-1 stores, for example, (in other words, updates) the sum of transmission time each time data transmission is performed, and performs the channel change request processing (e.g., FIG. 4) (S202). In the example illustrated in FIG. 7, child radio apparatus 20-1 determines to request a change of a radio channel. Then, child radio apparatus 20-1, for example, transmits data and information on the channel change request (e.g., the channel change request flag and the resolution time) to parent radio apparatus 10 (S203).

After receiving information on the channel change request from child radio apparatus 20-1, parent radio apparatus 10 performs channel change determination processing (e.g., FIG. 5) and selects a radio channel to be changed (S204).

Parent radio apparatus 10, for example, notifies (e.g., broadcasts) child radio apparatus 20-1 of the channel change instruction information indicating the selected radio channel (S205). Further, child radio apparatus 20-1 notifies (in other words, transfers) child radio apparatus 20-2 (in other words, lower child radio apparatus 20) of the notified channel change instruction information (S206).

After receiving the channel change instruction information, child radio apparatus 20-1 performs channel change processing (e.g., FIG. 6), and changes a radio channel used in radio 101 to the designated radio channel (S207). Similarly, after receiving the channel change instruction information, child radio apparatus 20-2 performs channel change processing (e.g., FIG. 6), and changes a radio channel used in radio 101 to the designated radio channel (S208). Further, parent radio apparatus 10 changes a radio channel used in radio 101 to the radio channel instructed to child radio apparatus 20 (S209).

The exemplary operation of radio apparatus 100 has been described above.

In the present embodiment, in radio network 1 in which the sum of transmission time per unit time is specified (in other words, limited), child radio apparatus 20 notifies parent radio apparatus 10 of the resolution time (in other words, the reduction time of the sum of transmission time) of the radio channel in which the sum of transmission time per unit time has exceeded the specification, and parent radio apparatus 10 selects at least one radio channel used for transmission among a plurality of radio channels based on the resolution time. Then, parent radio apparatus 10 and child radio apparatus 20 perform transmission on the selected radio channel.

This process allows each radio apparatus 100 to change a radio channel to be used, for example, to a radio channel with a shorter resolution time in radio network 1. Therefore, it is highly likely that radio apparatus 100 can, for example, transmit for a longer time on the changed radio channel among the plurality of radio channels, and thus it is possible to reduce a state in which transmission is paused due to the specification of the sum of transmission time per unit time (hereinafter, may be referred to as “transmission pausing state”).

For example, in radio apparatus 100, selecting a radio channel with a longer transmittable time when changing (in other words, switching) a radio channel can reduce the probability of pausing transmission due to the specification of the sum of transmission time per unit time for each radio channel. Further, for example, even when radio apparatus 100 enters the transmission pausing state, selecting a radio channel with a longer transmittable time can reduce the probability of pausing transmission according to the specification of the sum of transmission time per unit time for each radio channel when the transmission pausing state is resolved.

Further, in the selecting of a radio channel, selecting a radio channel with a longer transmittable time can, for example, reduce the switching of a radio channel in radio apparatus 100, and thus can reduce the processing amount (or processing complexity) in radio apparatus 100.

As described above, appropriate selection (switching) of a radio channel in a radio communication system can be realized according to the present embodiment.

One embodiment of the present disclosure has been described above.

In the embodiment described above, the same radio channel is set to each radio apparatus 100 at the same time in radio network 1, but the present disclosure is not limited thereto. For example, a different radio channel may be set for each child radio apparatus 20 and a different radio channel may be set for each group of child radio apparatus 20 (e.g., a group of child radio apparatus 20 corresponding to each branch in a tree-type network).

Further, in the above-described embodiment, the specified value of the sum of transmission time per unit time for each radio channel is not limited to 360 seconds, and may be another value. The specified value of the sum of transmission time per unit time in one radio apparatus is not limited to 720 seconds, and may be another value. Further, for example, unit time is not limited to one hour, and may be another unit of time.

In the embodiment described above, a case where parent radio apparatus 10 and each of child radio apparatuses 20 have a configuration of radio apparatus 100 (e.g., FIG. 2) has been described as an example, but the present disclosure is not limited thereto. For example, parent radio apparatus 10 may have a configuration of radio 101, controller 102, and channel selector 107 among the configuration of radio apparatus 100 illustrated in FIG. 2. Further, for example, child radio apparatus 20 may have a configuration of radio 101, controller 102, and transmission-time manager 104 among the configuration of radio apparatus 100 illustrated in FIG. 2.

In the above embodiment, a case where the number of radio channels to be selected is one at the time of the radio channel change has been described, but a plurality of radio channels may be selected.

In the embodiment described above, a case where radio apparatus 100 selects a radio channel based on the resolution time of the sum of transmission time per unit time, but the present disclosure is not limited thereto. In the embodiment of the present disclosure, radio apparatus 100 may select a radio channel used for transmission based on, for example, a degree of change (e.g., degree of decrease or degree of increase) of the sum of transmission time per unit time in each radio channel. For example, radio apparatus 100 may select a radio channel used for transmission based on the degree of increase (or the rate of increase) of the sum of transmission time per unit time in each channel. For example, when the degree of increase in the sum of transmission time per unit time is different depending on the usage status of each radio channel selectable by radio apparatus 100, radio apparatus 100 may preferentially select a radio channel having a smaller degree of increase in the sum of transmission time per unit time. In other words, a radio channel having a greater degree of increase in the sum of transmission time per unit time may be less likely to be selected as a radio channel used for transmission of radio apparatus 100.

The description has been given of embodiments with reference to the drawings, but the present disclosure is not limited to the examples. It is apparent that variations or modifications in the category described in the claims may be conceived by a person skilled in the art. It is to be understood that such variations or modifications fall within the technical scope of the present disclosure. In addition, component elements in the embodiment may be optionally combined without departure from the spirit of the present disclosure.

In the embodiments described above, the present disclosure has been described for an exemplary configuration using hardware. However, the present disclosure can be realized by software in cooperation with hardware.

Further, each functional block used in the description of each embodiment described above is typically implemented as a Large Scale Integration (LSI), which is an integrated circuit. The integrated circuit may control each functional block used in the description of the above embodiment, and may include an input and an output. The LSI may be individually formed as chips, or may be formed as one chip so as to include a part or all of the functional blocks. The LSI herein may be referred to as an Integrated Circuit (IC), a Small Scale Integration (SSI), a Middle Scale Integration (MSI), a system LSI, a super LSI, a Very Large Scale Integration (VLSI), or an ultra LSI depending on a difference in the degree of integration.

The technique of implementing an integrated circuit is not limited to the LSI and may be realized by using a dedicated circuit or a general-purpose processor. A Field Programmable Gate Array (FPGA) that can be programmed or a reconfigurable processor in which the connections and the settings of circuit cells disposed inside the LSI can be reconfigured may be used after the manufacture of the LSI.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a radio LAN system, a satellite system, etc., and various combinations thereof. The communication apparatus may include a device such as a controller or a sensor which is coupled to a communication device performing a function of communication described in the present disclosure. For example, the communication apparatus may include a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

In the above description, the term “ . . . er (or)” used for the name of a component may be replaced with another term such as “circuitry”, “assembly”, “device”, “unit”, or “module”.

### SUMMARY OF EMBODIMENTS

A radio communication apparatus according to the embodiment of the present disclosure includes: control circuitry, which, in operation, selects, as a radio channel used for transmission, at least one radio channel among a plurality of radio channels based on information on a reduction time of a sum of transmission time per unit time in each of the plurality of radio channels; and radio circuitry, which, in operation, performs transmission using the selected radio channel.

In the embodiment of the present disclosure, the control circuitry selects the radio channel used for transmission when a change request for a radio channel from another radio communication apparatus is received.

In the embodiment of the present disclosure, the change request indicates that the sum of transmission time per unit time has exceeded a threshold value based on a specified value in at least one of the plurality of the radio channels in the other radio communication apparatus.

In the embodiment of the present disclosure, the radio circuitry receives information on the reduction time from the other radio communication apparatus.

In the embodiment of the present disclosure, the information on the reduction time indicates a time taken for the sum of transmission time to decrease to less than a threshold value smaller than a specified value.

In the embodiment of the present disclosure, the control circuitry selects the radio channel used for transmission based on a usage status of each of the plurality of radio channels.

A radio communication apparatus according to the embodiment of the present disclosure includes: radio circuitry, which, in operation, transmits, to another radio communication apparatus, information on a reduction time of a sum of transmission time of a radio channel in which the sum of transmission time per unit time has exceeded a threshold value based on a specified value; and radio circuitry, which, in operation, performs transmission using a radio channel selected in the other radio communication apparatus based on the information on the reduction time.

In a radio communication method according to the embodiment of the present disclosure, a radio communication apparatus selects, as a radio channel used for transmission, at least one radio channel among a plurality of radio channels based on information on a reduction time of a sum of transmission time per unit time for each of the plurality of radio channels; and performs transmission using the selected radio channel.

In a radio communication method according to another radio communication apparatus, information on a reduction time of a sum of transmission time of a radio channel in which the sum of transmission time per unit time has exceeded a threshold value based on a specified value; and performs transmission using a radio channel selected in the other radio communication apparatus based on the information on the reduction time.

A radio communication system according to the embodiment of the present disclosure includes a first radio communication apparatus and a second radio communication apparatus, and the first radio communication apparatus transmits, to the second radio communication apparatus, information on a reduction time of a sum of transmission time of a radio channel in which the sum of transmission time per unit time has exceeded a threshold value based on a specified value; the second radio communication apparatus selects, as a radio channel used for transmission, at least one radio channel among a plurality of radio channels based on the information on the reduction time of the sum of transmission time per unit time in each of the plurality of radio channels; and the first radio communication apparatus and the second radio communication apparatus perform transmission using the selected radio channel.

The disclosure of Japanese Patent Application No. 2020-022679, filed on Feb. 13, 2020, including the specification, drawings and abstract, is incorporated herein by reference in its entirety.

### INDUSTRIAL APPLICABILITY

The present disclosure is applicable to a radio communication system.

### REFERENCE SIGNS LIST

1 Radio network
10 Parent radio apparatus
20 Child radio apparatus
100 Radio apparatus
101 Radio
102 Controller
103 Memory
104 Transmission-time manager
105 Transmission-time memory
106 Solution-time calculator
107 Channel selector

1. A radio communication apparatus, comprising:
control circuitry, which, in operation, selects, as a radio channel used for transmission, at least one radio channel among a plurality of radio channels based on information on a reduction time of a sum of transmission time per unit time in each of the plurality of radio channels; and
radio circuitry, which, in operation, performs transmission using the selected radio channel.

2. The radio communication apparatus according to claim 1, wherein
the control circuitry selects the radio channel used for transmission when a change request for a radio channel from another radio communication apparatus is received.

3. The radio communication apparatus according to claim 2, wherein
the change request indicates that the sum of transmission time per unit time has exceeded a threshold value based on a specified value in at least one of the plurality of the radio channels in the other radio communication apparatus.

4. The radio communication apparatus according to claim 2, wherein
the radio circuitry receives information on the reduction time from the other radio communication apparatus.

5. The radio communication apparatus according to claim 1, wherein
the information on the reduction time indicates a time taken for the sum of transmission time to decrease to less than a threshold value smaller than a specified value.

6. The radio communication apparatus according to claim 1, wherein
the control circuitry selects the radio channel used for transmission based on a usage status of each of the plurality of radio channels.

7. A radio communication apparatus, comprising:
radio circuitry, which, in operation, transmits, to another radio communication apparatus, information on a reduction time of a sum of transmission time of a radio channel in which the sum of transmission time per unit time has exceeded a threshold value based on a specified value; and
radio circuitry, which, in operation, performs transmission using a radio channel selected in the other radio communication apparatus based on the information on the reduction time.

8. A radio communication method, comprising:
selecting, by a radio communication apparatus, as a radio channel used for transmission, at least one radio channel among a plurality of radio channels based on information on a reduction time of a sum of transmission time per unit time for each of the plurality of radio channels; and
performing, by the radio communication apparatus, transmission using the selected radio channel.

9. A radio communication method, comprising:
transmitting, by a radio communication apparatus, to another radio communication apparatus, information on a reduction time of a sum of transmission time of a radio channel in which the sum of transmission time per unit time has exceeded a threshold value based on a specified value; and
performing, by the radio communication apparatus, transmission using a radio channel selected in the other radio communication apparatus based on the information on the reduction time.

10. A radio communication system, comprising:
a first radio communication apparatus; and
a second radio communication apparatus, wherein
the first radio communication apparatus transmits, to the second radio communication apparatus, information on a reduction time of a sum of transmission time of a radio channel in which the sum of transmission time per unit time has exceeded a threshold value based on a specified value,
the second radio communication apparatus selects, as a radio channel used for transmission, at least one radio channel among a plurality of radio channels based on the information on the reduction time of the sum of transmission time per unit time in each of the plurality of radio channels, and
the first radio communication apparatus and the second radio communication apparatus perform transmission using the selected radio channel.
